(19) United States
(12) Patent Application Publication
(10) Pub. No.: US 2022/0381460 A1
(43) Pub. Date: Dec. 1, 2022

(54) PASSIVE/ACTIVE VENTILATION AND LIGHTING SYSTEM, APPARATUS, AND METHOD OF USING THE SAME

(71) Applicant: Richard Michael Brindisi, Bullhead City, AZ (US)

(72) Inventor: Richard Michael Brindisi, Bullhead City, AZ (US)

(21) Appl. No.: 17/804,346

(22) Filed: May 27, 2022

Related U.S. Application Data
(60) Provisional application No. 63/193,911, filed on May 27, 2021.

(51) Int. Cl. F24F 7/02; F21S 9/03; F21V 33/00; F21V 21/04

(52) U.S. Cl. CPC F24F 7/025; F21S 9/037; F21V 33/0096; F21V 21/047; F21Y 2115/10

(57) ABSTRACT

A singular passive/active ventilation and lighting apparatus for enclosed spaces. The apparatus is adapted to harness solar energy through a cover which also directs light down through a reflective tube. The apparatus provides a passive vent which is fluidly coupled to the same reflective tube. As the reflective tube couples the external environment with an enclosed space, passive/active ventilation and passive/active light is directed to the enclosed space. The solar energy is directed to other components supported by the singular apparatus, like the active lighting and active ventilation fan as well as a wireless router, an electric charger and power storage unit for storing the harnessed solar energy and powering the active components.

### CROSS-REFERENCE TO RELATED APPLICATION

This application claims the benefit of priority of U.S. provisional application No. 63/193,911, filed 27 May 2021, the contents of which are herein incorporated by reference.

### BACKGROUND OF THE INVENTION

The present invention relates to passive/active ventilation and lighting systems and apparatuses and, more particularly, a combination passive/active ventilation and lighting apparatus that incorporates passive/active lighting and passive/active roof ventilation, as well as a mobile router, an auxiliary battery storage, and other electronic components. The passive/active lighting is in the form of a solar light tube optically coupled to the external environment and solar-powered LED lighting operatively associated with the solar light tube. The passive/active roof ventilation is through a passive vent head and a solar-powered axial fan, both operatively associated with the solar light tube.

Confined interior spaces without window are commonly used for storage. Typical examples are long-term storage units, attics, distribution centers, and the like. These windowless spaces tend to be dark and, in certain climates, retain excessive heat. The latter can be problematic as high temperatures can damage many items that are found in long-term storage units and attics, such as certain fabrics and glued-together items that may begin to delaminate. While darkness is rather off-putting and inconvenient to those who visit the confined space.

With that said, in many situations it can be prohibitively expensive to enable active ventilation by installing ductwork and active lighting by run electrical wiring for the confined space. Accordingly, passive ventilation and passive lighting solutions suggest themselves; however, each separate hole cut in the roof of the confined space to add a passive/active vent or a separate skylight is a liability, each having a probability of resulting in unacceptable leakage and, of course, adding to the expense of time and money for installation. The greater number of holes compounds the probability of leakage.

As can be seen, there is a need for a combination passive/active ventilation and lighting apparatus that incorporates passive/active lighting and passive/active roof ventilation, as well as a mobile router, an auxiliary battery storage, and other electronic components.

The present invention provides natural daylight into darkened spaces during the day through a solar light tube and solar-powered LED lighting at night, wherein the LED lighting is operatively associated with the solar light tube to take advantage of its reflective inner surface. Furthermore, the invention acts as a passive/active ventilation unit for the enclosed space by way of passive vent head and a solar-powered axial fan, both of which are operatively associated with the solar light tube. The assembly also generates electrical power through photovoltaic panels, allowing for electrical charging of a power source as well as activating a myriad of electronic components, such as a mobile router access for cell phones for off-grid confined spaces.

The present invention solves these problems by combining a passive/active roof vent with a solar and LED light tube. Also, a mobile router and a USB battery charger can all be built into this singular combination unit powered by the above-mentioned solar panels integrated into the present invention. Additionally, the present invention may house a solar powered battery for powering the LED lighting and other components, the external battery charged devices, and a wireless router. While vent head exhausts gases and heat from the confined spaces. The solar powered battery harnesses natural daylight and gives a renewable energy source to power the LED lights,

This apparatus embodied in the present invention addresses problems in one singular unit as opposed to having multiple devices with multiple roof penetrations/locations to accomplish the same tasks. Another aspect of the disclosure is an adjustable multi-pitch bracket system that enables installation on a variety of roof surfaces.

In short, the present invention manages to eliminate roof penetrations by housing passive lighting and venting components in one unit that is selectively suitable for different roofing types and pitches. The present invention does everything the prior art devices do while being a true out of the box solution with a singular housing as well as being a rechargeable energy source for the many components and features it provides.

### SUMMARY OF THE INVENTION

In one aspect of the present invention, a system for passively and actively illuminating and venting an enclosed space, the system including the following a singular opening connecting the enclosed space to an external environment; a tube optically and fluidly coupling the enclosed space and the external environment by way of the singular opening, wherein the tube has a specular inner surface; a translucent cover covering a distal end of the tube; and a vent head subjacent the cover, wherein the vent head is fluidly coupled to the tube.

In another aspect of the present invention, the system further includes one or more perimetral solar paneling immediately downward of the translucent cover, wherein the translucent cover is dome shape, wherein the dome shape has a cover diameter approximately that of an inner paneling diameter defined by the one or more perimetral solar paneling (as illustrated in FIG. 4); further including a plurality of adjustable brackets connected to an external surface of the tube; and a roof base that shrouds the plurality of adjustable brackets, wherein the roof base has an upper portion, a lower portion, and a flashing portion; the upper portion connects to the tube upward of the plurality of adjustable brackets; the lower portion has a radial outward taper as it extends away from the upper portion; and the flashing portion extends radially from the lower portion; further including an axial fan disposed in a lumen defined by the tube; further including one of more light emitting devices disposed adjacent a proximal end of the tube, wherein the proximal end has a reflective lens viewable from within the enclosed space; further including a wireless router and an electrically charger, wherein the one or more perimetral solar paneling is electrically coupled to an energy storage unit operatively coupled to the wireless router and the electrically charger.

In yet another aspect of the present invention, a method of illuminating and venting an enclosed space while minimizing leakage from an external environment to the enclosed space, the method including providing only a single installation opening between the enclosed space the external environment; and installing the above-mentioned system in the single installation opening so that the translucent cover and vent head are operatively associated with the external environment, and a proximal end of the tube operatively associates with the enclosed space.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention, shown in use.

FIG. 2 is a bottom perspective view of an exemplary embodiment of the present invention, shown in essence without the light tube 16 for clarity.

FIG. 3 is an exploded perspective view of an exemplary embodiment of the present invention.

FIG. 4 is a top plan view of an exemplary embodiment of the present invention.

FIG. 5 is a bottom plan view of an exemplary embodiment of the present invention.

FIG. 6 is a side elevation view of an exemplary embodiment of the present invention, shown in essence without the light tube 16 for clarity.

FIG. 7 is a section view of an exemplary embodiment of the present invention, taken along line 7-7 in FIG. 4.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a singular passive/active ventilation and lighting apparatus for enclosed spaces. The apparatus is adapted to harness solar energy through a cover which also directs light down through a reflective tube. The apparatus provides a passive vent which is fluidly coupled to the same reflective tube. As the reflective tube couples the external environment with an enclosed space, passive/active ventilation and passive/active light is directed to the enclosed space. The solar energy is directed to other components supported by the singular apparatus, like the active LED lighting and active ventilation fan as well as a wireless router, a USB charger and power storage unit for storing the harnessed solar energy and powering the active components.

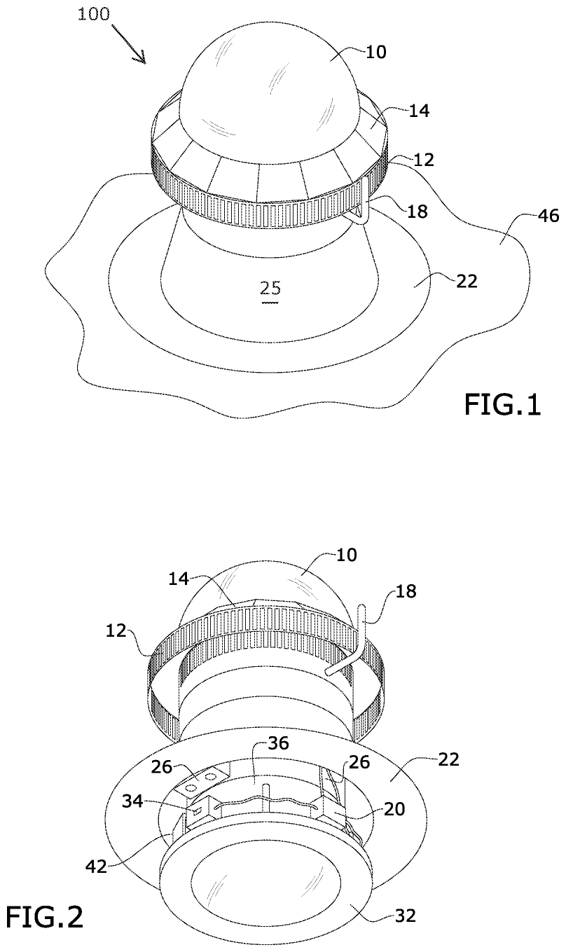

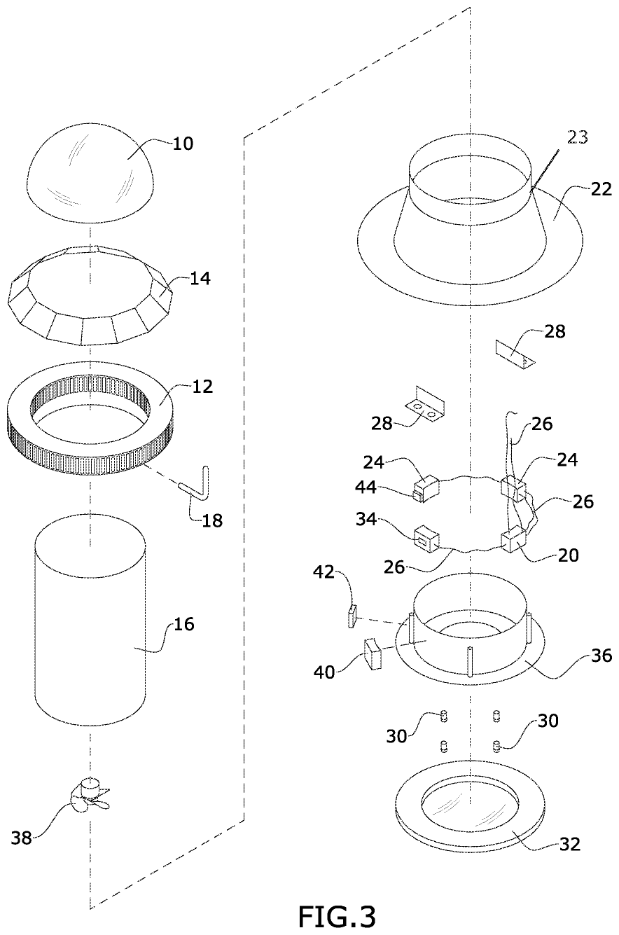

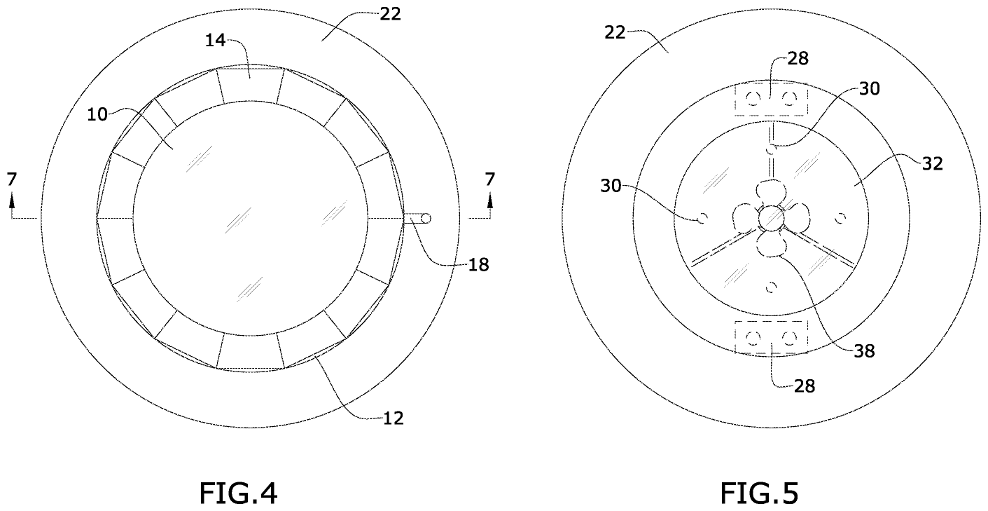

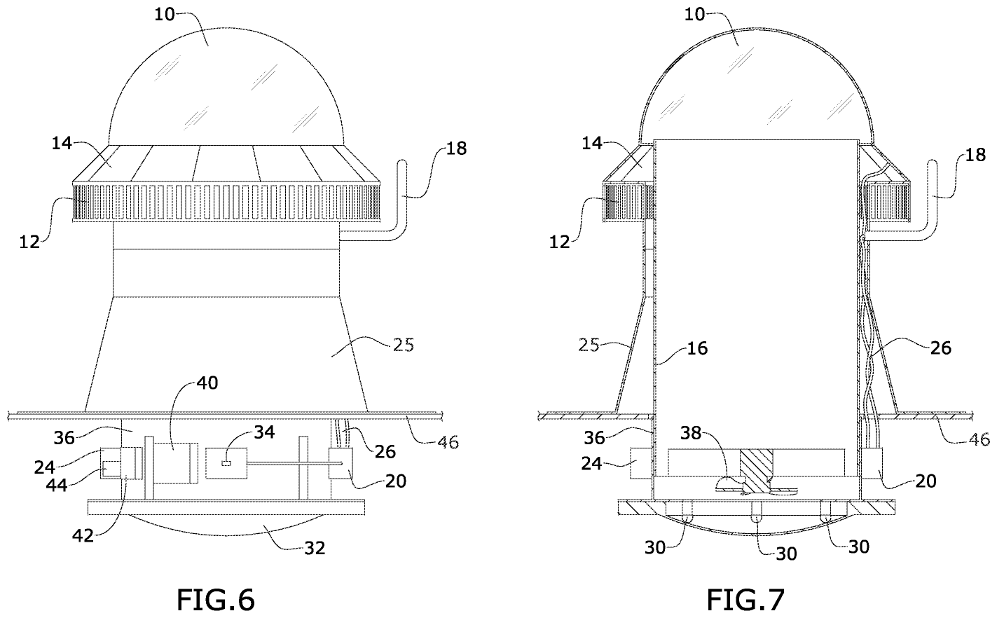

Referring now to FIGS. 1 through 7, the present invention may include a singular passive unit 100 combining passive/active lighting and passive/active ventilation functionality for a confined space, via that space's roof/ceiling system 46. The singular passive unit 100 may combine a cover 10 and vent head 12.

The cover 10 may enable visible light to pass through. In certain embodiments, the cover may be dome-shaped and made of acrylic or other translucent material having a sufficient light transmission efficiency such that, at typical daytime ambient light levels, sufficient light is transmitted into the enclosure to permit human visibility therein. The cover 10 may be optically coupled to a light tube 16. The light tube 16 may be cylindrical and have a length ranging from twenty-four to sixty inches depending on its utilization. The cover 10 is typically located at the upper most portion of the passive unit 100. The light tube 16 may have a reflective and/or specular inner (circumferential) surface for reflecting and/or refracting the receive light by way of the cover 10 downward to the confined space, to which the light tube 16 is optically and fluidly coupled. In certain embodiments, specular reflective film may line the inner surface of the light tube 16. The cover 10 allows for solar light to reflect off the reflective light tube 16 and then refract off a reflective lens 32 located at the lower end of the light tube 16, within the enclosed space, thereby displacing external light below the roof line to said enclosed space.

Subjacent the cover 10 may be the vent head 12 that is fluidly coupled to the light tube 16 so that air from the external environment may flow through the light tube 16 and into the confined space, and vice versa, thereby ventilating the enclosed space. The passive vent head 12 is adapted for the displacement of room interior fumes, gases, etc. The passive vent head 12 may structurally support the cover 10.

Also, along an outer surface of the passive unit 100 may be solar paneling 14. The solar paneling may be immediately subjacent the cover 10 so that light reflecting off the cover 10 or out of (through) the cover (from the light tube 16) may contact the solar paneling 14. Moreover, the dome-shape of the cover 10 facilitates contact/collection of this reflected and reverse pass-through light. Accordingly, the solar paneling 14 may form a ring just beneath the cover 10. The passive vent head 12 may also structurally hold the solar paneling 14. The solar paneling 14 may provide power to the rechargeable batteries 24 or other power storage units.

A roof base 23 may be dimensioned and adapted to retain the cover 10, vent head 12, and solar paneling 14 while connecting the singular passive unit 100 to an upper surface of the roof system 46. The roof base 23 may have roof flashing 22 that radially extends from a lower portion 25 thereof, much like a flange. The radial extension of the roof flashing 22 enables the roof base 23 to engage a variety of roof surfaces. A plurality of roofing brackets 28 engage an exterior surface of the light tube 16 to connect it to the roof system 46. The roofing bracket 26 may be L-shaped or otherwise dimensioned and adapted to adjustably interconnect the light tube 16 to the roof system 46, thereby enabling an adjustable multi-pitch bracket system for accommodating various roof pitches. The lower portion 25 of the roof base 23 may radially taper away from the light tube 16 as the lower portion 25 transitions from an toward the roof flashing 22, creating space for the roofing brackets 28 which are in turn shrouded by the lower portion 25. The roof flashing 22 provides for weatherproofing of the interior space and protects internal components. Thereby the singular passive unit 100 can be installed on a variety of roof pitches and roof types easily with basic skill and tools.

The singular passive unit 100 may house multiple technologies, including but not limited to light emitting diode (LED) lighting 30, an axial fan, wireless router 40 access by way of an antenna 18 and a Universal Serial Bus (USB) charging device 34. The rechargeable batteries 24 may provide the power for these functionalities and any other powered devices. An electric power connector 20 and wire harnesses 26 may facilitate the transfer power to theses electric devices. By capturing and harnessing the sun's energy with the solar panel ring 14, the present invention can effectively power these devices and provide both natural and LED lighting in darkened spaces while at the same time providing passive/active ventilation and USB power and wireless internet access.

The lower portions of the light tube 16 terminates at the reflective lens 32 which is supported by an enclosure base ring 36. In between the lower portion and the upper portion (at the roof system 46) the light tube 16 may support the LED lighting devices 30, the fan 38, a carbon dioxide monitor 42, the DC power adaptor 44, and the like.

The light tube 16 may be manufactured by cutting sheet metal to desired length and width and rolling to accomplish the tube's shape. A reflective film surface may be affixed to the interior of the tube surface to allow refraction of light. A spun shaped vent head 12 may then be put on the resulting light tube 16 with a clear acrylic dome cover 10 to provide for the invention's most basic function. The solar panel ring 14 and wiring could be connected to the vent head 12. This assembly may then be connected to the LED lighting 30 that would be defused through the reflective lens 32. The roof flashing 22 could be formed from PVC sheet material through thermal plastic forming. The brackets 28 may be attached to the light tube 16 itself and all wiring would then be attached as well. Lastly, the wireless router 40 and the USB charger 34 would be mounted under the vent head 12 with a wire coming at the bottom of the light tube 16. The disclosure can be modified to incorporate other technologies such as the carbon dioxide monitor 42, a direct current (DC) power adaptor 44 and the axial fan 38.

A method of using the present invention may include the following. The passive/active unit 100 disclosed above may be provided. A user would install the present invention on a roof, through a single, monolithic opening, which would allow the passive/active lighting and venting and solar power the above mentioned devices.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system for passively and actively illuminating and venting an enclosed space, the system comprising:
a singular opening connecting the enclosed space to an external environment;
a tube optically and fluidly coupling the enclosed space and the external environment by way of the singular opening, wherein the tube has a specular inner surface;
a translucent cover covering a distal end of the tube; and
a vent head subjacent the cover, wherein the vent head is fluidly coupled to the tube.

2. The system of claim 1, further comprising:
one or more perimetral solar paneling immediately downward of the translucent cover.

3. The system of claim 2, wherein the translucent cover is dome shape, wherein the dome shape has a cover diameter approximately that of a inner paneling diameter defined by the one or more perimetral solar paneling.

4. The system of claim 3, further comprising:
a plurality of adjustable brackets connected to an external surface of the tube; and
a roof base that shrouds the plurality of adjustable brackets.

5. The system of claim 4, wherein the roof base has an upper portion, a lower portion, and a flashing portion;
the upper portion connects to the tube upward of the plurality of adjustable brackets;
the lower portion has a radial outward taper as it extends away from the upper portion; and
the flashing portion extends radially from the lower portion.

6. The system of claim 5, further comprising an axial fan disposed in a lumen defined by the tube.

7. The system of claim 6, further comprising one of more light emitting devices disposed adjacent a proximal end of the tube, wherein the proximal end has a reflective lens viewable from within the enclosed space.

8. The system of claim 7, further comprising a wireless router and an electrically charger.

9. The system of claim 8, wherein the one or more perimetral solar paneling is electrically coupled to an energy storage unit operatively coupled to the wireless router and the electrically charger.

10. A method of illuminating and venting an enclosed space while minimizing leakage from an external environment to the enclosed space, the method compromising:
providing only a single installation opening between the enclosed space the external environment; and
Installing the system of claim 1 in the single installation opening so that the translucent cover and vent head are operatively associated with the external environment, and a proximal end of the tube operatively associates with the enclosed space.
